(19) United States
(12) Patent Application Publication
(10) Pub. No.: US 2002/0036632 A1
(43) Pub. Date: Mar. 28, 2002

(54) Image processor, image processing method, and recording medium for storing image processing programs

(76) Inventors: Masaaki Kuriyama, Kawasaki (JP); Toshihiro Hamamura, Osaka (JP); Masahito Niikawa, Sakai (JP)

Correspondence Address: Tyler S. Brown, Morrison & Foerster LLP, Suite 5500, 2000 Pennsylvania Avenue, N.W., Washington, DC, 20006-1888, US

(21) Appl. No.: 09/961,388

(22) Filed: Sep. 25, 2001

(30) Foreign Application Priority Data
Sep. 28, 2000 (JP) 00-0296462

(51) Int. Cl. G09G 5/00

(52) U.S. Cl. 345/204; 345/473

(57) ABSTRACT

An image processor reduces the load on a user when selecting a frame image from among a group of frame images comprising a dynamic image by executing a specific process for printing and editing. The image processor includes a display controller for displaying a still frame image of a dynamic image with a stop time, and a group of temporally consecutive frame images with the still frame image as the center frame image.

### RELATED APPLICATION

This application is based on Patent Application No. 2000-296462 filed in Japan, the content of which is hereby incorporated by reference.

### BACKGROUND OF THE INVENTION

1. Field of the Invention

The present invention relates to image processing art, and specifically relates to processing when selecting one frame image from among a group of frame images comprising a dynamic image.

2. Description of the Related Art

Still images and dynamic images photographed by a digital still camera and digital video camera are often recorded on information recording media such as a CD-ROM, compact flash, or smart disk for convenience in storage and transport.

A plurality of still images and dynamic images can be recorded on such information recording media. When a user prints or edits a recorded image, the image to be printed or edited is selected in an information processing device such as a personal computer.

Regarding dynamic images in particular, a user can read a single still image included in a dynamic image and print or edit the image because the dynamic image comprises a plurality of frame images (still images) which are temporally consecutive. Since a frame image is displayed at 30 frames per second, it is difficult for a user to select a desired single frame from among a group of displayed frame images, which change momentarily while the screen display is being viewed.

These problems are generally solved by displaying each single frame of a dynamic image, and selecting and displaying one frame from among those displayed (e.g., Japanese Laid-Open Patent No. H11-103441), displaying the compressed images of a number of frames before and after a still image of a specified single frame as multiple images, and selecting an optional frame from these compressed images (Japanese Laid-Open Patent No. H11-275515).

In these methods, however, many frame images are displayed when editing, which increases the load when a user is selecting an image in a photograph. Alternatively, handling data when still image and dynamic image data are stored in a mixed state presents yet another problem.

### SUMMARY OF THE INVENTION

To resolve these problems, an aspect of the present invention is to provide an image processor which reduces the load on the user when selecting a frame image from among a group of frame images comprising a dynamic image by executing specific processing for printing and editing.

A first image processor of the present invention comprises a display device for displaying a dynamic image comprised of a plurality of temporally consecutive frame images, a stopping device for stopping the display of a dynamic image displayed on the display device with an optional timing, and a display controller for displaying, as a still image on the display device, a frame image displayed with a stop timing and a group of frame images in a specified range having the stopped frame image as a center frame image.

In the first image processor, the display controller also need not display the dynamic image when displaying a still image.

In the first image processor, the time interval between adjacent frame images in a group of frame images also may be set so as to increase the temporal separation from the center frame image.

The first image processor may be further provided with a setting device for setting a time spacing between frame images in a group of frame images.

In the first image processor, the display controller also may modify the setting of the time interval by the setting device, and update the display state of the display device so as to display the group of frame images at the modified time interval.

A second image processor of the present invention comprises a display device for displaying a dynamic image comprised of a plurality of temporally consecutive frame images, a stopping device for stopping the display of a dynamic image displayed on the display device with an optional timing, and a display controller for subjecting a frame image displayed with stop timing to specific image processing and display on the display device when a dynamic image is stopped by the stopping device.

In the second image processor, the display controller, in addition to a frame image displayed with stop timing, may subject a group of frame images temporally before and after a center frame image to specific image processing and display as a still image on the display device.

The second image processor may be further provided with a selector for selecting one image among images displayed on the display device for specific processing.

Furthermore, the second image processor may be provided with a printing device for printing an image selected by the selector.

The image processing method of the present invention displays a dynamic image comprising a plurality of temporally consecutive frame images, stops the display of the displayed dynamic image with an optional timing, and displays, as still images, the frame image displayed with stop timing and the group of frame images within a specific range with the stopped frame image at the center when the dynamic image display is stopped.

Another image processing method of the present invention displays a dynamic image comprising a plurality of temporally consecutive frame images, stops the display of the displayed dynamic image with an optional timing, and subjects the frame image displayed with stop timing to specific processing for display when the dynamic image display is stopped.

The recording medium of the present invention is a computer-readable recording medium for recording image processing programs. The image processing programs are executed by computer and comprise a process of displaying a dynamic image comprising a plurality of temporally consecutive frame images, a process of stopping the display of the displayed dynamic image with an optional timing, and a process of displaying, as still images, the frame image displayed with stop timing and the group of frame images within a specific range with the stopped frame image at the center when the dynamic image display is stopped.

Another recording medium of the present invention is a computer-readable recording medium for recording image processing programs. The image processing programs are executed by computer and comprise a process of displaying a dynamic image comprising a plurality of temporally consecutive frame images, a process of stopping the display of the displayed dynamic image with an optional timing, and a process of subjecting the frame image displayed with stop timing to specific processing for display when the dynamic image display is stopped.

These and other objects, advantages and features of the invention will become apparent from the following description thereof taken in conjunction with the accompanying drawings which illustrate specific embodiments of the invention.

### BRIEF DESCRIPTION OF THE DRAWINGS

In the following description, like parts are designated by like reference numbers throughout the several drawings.

FIG. 1 is a structural view of the image processor of the present invention.

FIG. 2 is a flow chart showing the main flow of the image processor of the present invention.

FIG. 3 is a flow chart showing the image display process (first embodiment).

FIG. 4 illustrates the condition of an image read from a recording medium displayed as a thumbnail image.

FIG. 5 shows an enlarged display of a still image selected for the printing process.

FIG. 6 shows an image display when displaying an intermittent frame image selected from among a plurality of frame images comprising a dynamic image selected for the printing process.

FIG. 7 is a flow chart of a display frame number calculation process (first embodiment).

FIG. 8 is a flow chart of an image display process (second embodiment).

FIG. 9 shows an enlarged display of a dynamic image selected for the printing process.

FIG. 10 shows an image display when viewing, as still images, a specific group of frame images before and after a stopped frame image when a dynamic image display of a selected dynamic image is stopped.

FIG. 11 is a flow chart of the display frame number calculation process (second embodiment).

FIG. 12 shows an image display when viewing a group of frame images when the display frame spacing is increased from the center.

FIG. 13 shows an image display when displaying images after each image of a group of frame images has been subjected to specific image processing.

### DESCRIPTION OF THE PREFERRED EMBODIMENTS

The embodiments of the image processor of the present invention are described hereinafter with reference to the accompanying drawings.

First Embodiment

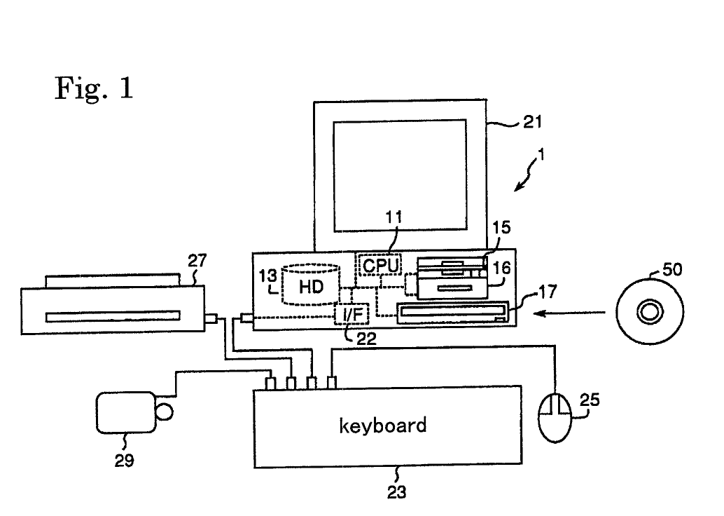

FIG. 1 shows the structure of an image processor of the present invention. As shown in the drawing, an image processor 1 is provided with a CPU 11 for controlling operations and realize functions described later by executing specific programs. The specific programs executed by the CPU 11 can be provided by a recording medium such as a CD-ROM 50 or the like. The image processor 1 is provided with a hard disk 13 for storing data and programs executed by the CPU 11, display 21 for displaying image data and displays for user operations, and interface 22 for exchanging control information and data with external information devices. Connected to the image processor 1 through the interface 22 are a keyboard 23 and mouse 25 for user input operations, printer 27, and digital camera (includes functions of both still camera and video camera) 29. The image processor 1 is further provided with a floppy disk drive 15 for reading data from a floppy disk, drive 16 for reading data from a memory card such as a compact flash or smart media, and CD-ROM drive for reading data from a CD-ROM 50.

The operation of the image processor of the aforesaid structure is described below.

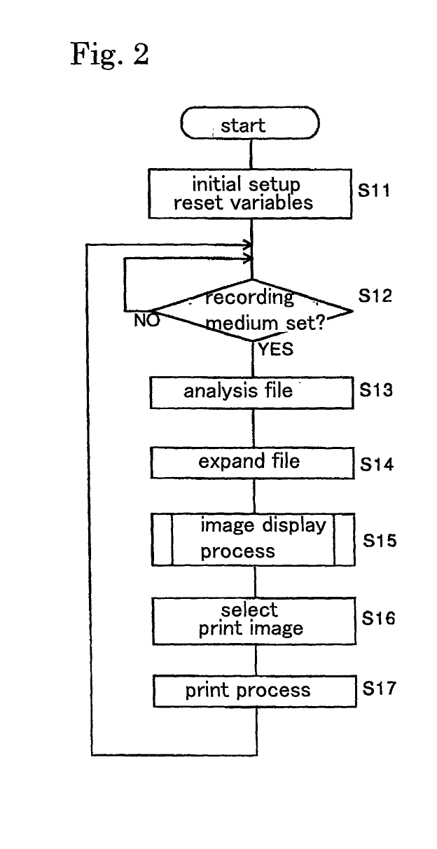

FIG. 2 is a flow chart showing the main flow of operation of the image processor 1. This process is controlled by the CPU 11 and normally starts after a power source is applied to the image processor 1.

As shown in FIG. 2, first, the initial settings, variables, and flags required to control the image processor are initialized and reset (S11). A check is made to determine whether or not a recording medium containing image data such as a floppy disk, memory card, CD-ROM or the like has been loaded in a corresponding drive in the image processor (S12).

When a recording medium has been inserted in a drive, the data recorded on the recording medium are analyzed (S13). For example, a determination is made as to whether or not image data recorded on the recording medium are dynamic image data or still image data. The result is stored on the hard disk 13.

Thereafter, the image data recorded on the recording medium are expanded (S14). Normally, the image data are compressed when recorded on the recording medium due to the large amount of data. The total number of frames of the expanded image data and dynamic image data among the expanded images are saved beforehand on the hard disk 13.

In the present embodiment, the image data are already recorded on the recording medium.

Table 1

The dynamic image file format is audio video interleave (AVI). After expansion, an image display process is executed to display a summary of the expanded image data on the display 21 (S15). A user selects an image to print while referring to the summary of the image data displayed on the display 21. (Details of the image display process are described later). Thereafter, information of the user-selected image to be printed is acquired (S16). Then, the print process is executed for the image (S17). Thereafter, the routine returns to step S12 and the loading of the next recording medium is awaited.

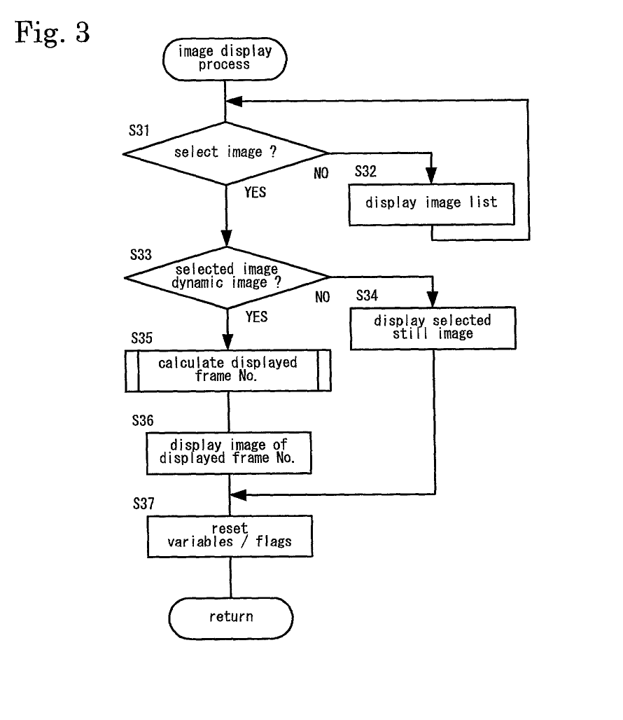

Details of the image display process are described with reference to FIG. 3. In this process, a summary of the image data read from the recording medium is displayed on display 21. At this time, when a dynamic image is selected as an image to be printed by a user, a group of frame images intermittently determined as part of all the frames comprising the dynamic image are displayed in summary for ultimate selection. The summary display of the group of displayed frame images is referred to as the frame summary hereinafter. In the present embodiment, the display frame is determined so as to display a specific number of frame images set beforehand in the frame summary.

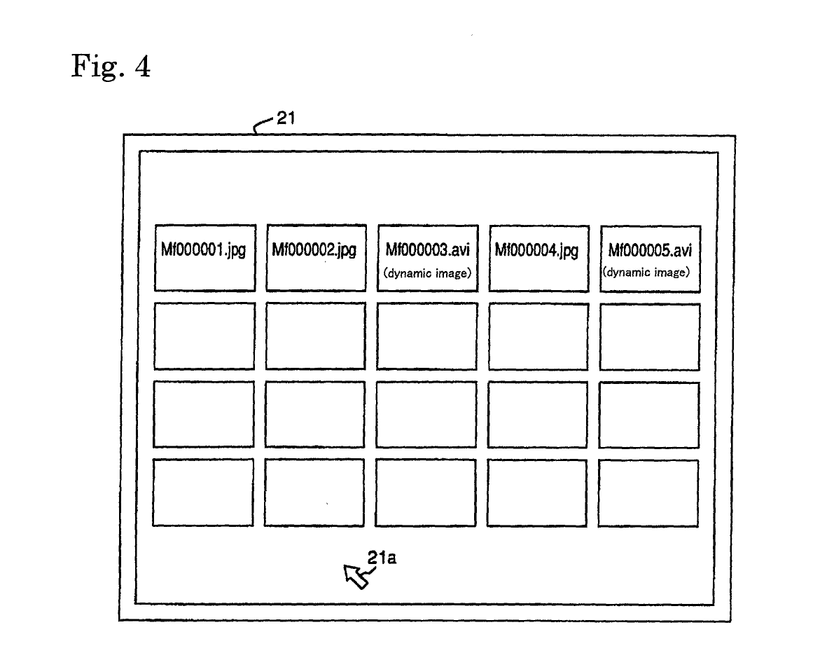

Referring to FIG. 3, first, a determination is made as to whether or not an image has been selected by the user via the keyboard 23 and mouse 24 (S31). If an image has not yet been selected, a thumbnail image of the expanded image is displayed (S32). An example of the expanded image summary display is shown in FIG. 4. Still image data are displayed as a still image, and dynamic image data are displayed as a dynamic image. For example, in dynamic image data of Mf000003.avi, the dynamic image is regenerated by displaying the frames consecutively repeated in the sequence frame No. 0→frame No. 1→ . . . →frame No. 99→frame No. 0→fame No. 1 . . . . The frame No. 0 of the dynamic image may be displayed as a representative still image.

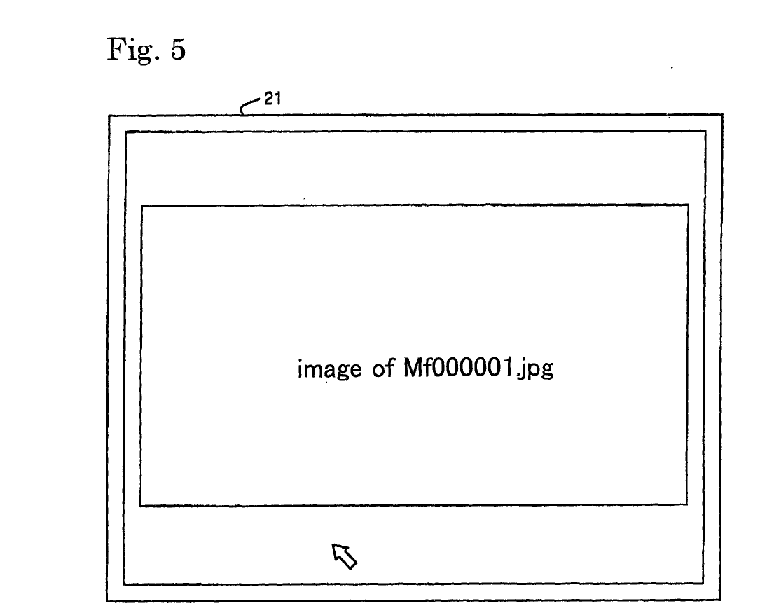

Thereafter, when one image among the image summary shown in FIG. 4 is selected by the mouse cursor by user operation of the mouse 25, a determination is made as to whether or not the selected image is a dynamic image (S33). If the selected image is a still image, the image is expanded and displayed (S34) as shown in FIG. 5, and the routine advances to step S37.

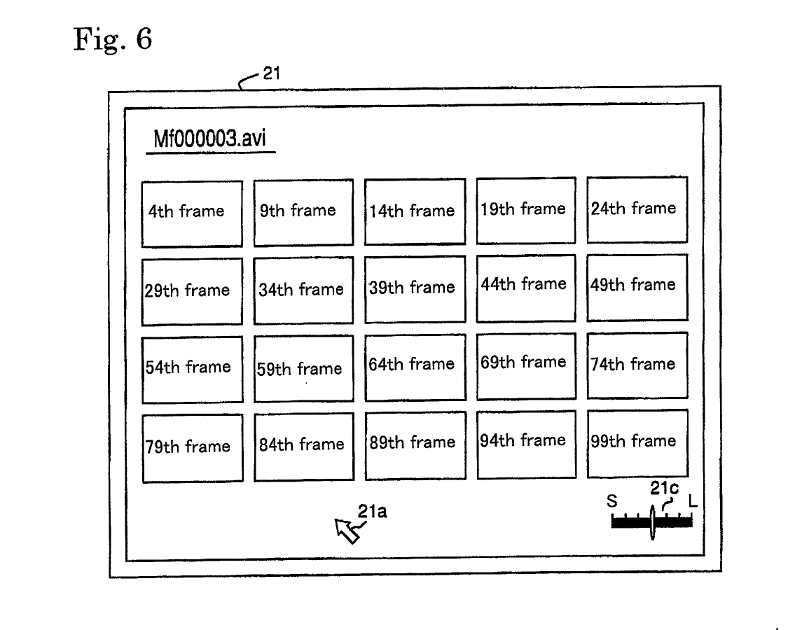

On the other hand, when the selected image is a dynamic image, a group of intermittently selected frame images are displayed in summary from among the frame images comprising the dynamic image data so that the user can select one frame image from among a plurality of frame images comprising the dynamic image data. For this reason, first, a process is executed for determining the frame number of each frame image of the group of frame images displayed in the frame summary (S35). (Details of this process are described later). Then, the group of frame images for which frame numbers have been determined are displayed on the display 21 (S36). Thereafter, variables and flags are reset (S37) and the routine returns. FIG. 6 shows an example of the frame summary display. In this drawing, the group of frame images is displayed together with a slide volume 21c for setting the time interval when determining the frame image. The time interval can be adjusted (increased/decreased) when determining the frame image group in accordance with the software by shifting the slide volume 21c position to left or right.

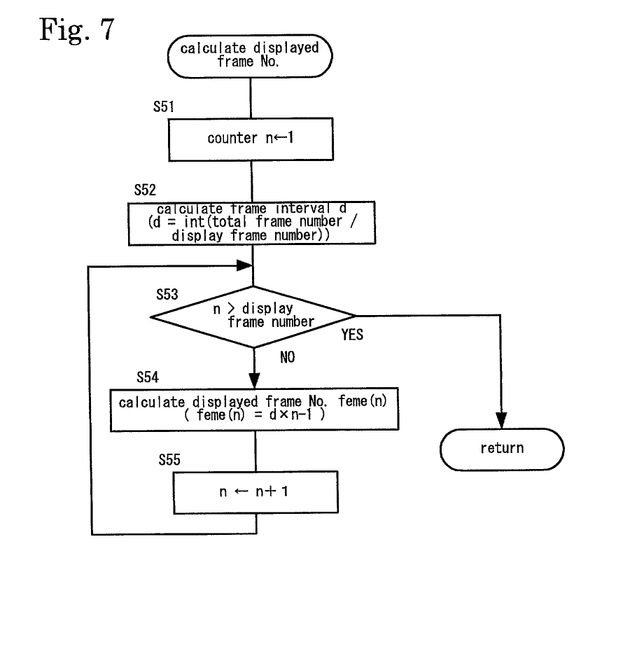

The display frame number calculation process (step S35) is described below with reference to FIG. 7.

The description below pertains to an example when the dynamic image file Mf000003.avi is selected, the frame number displayed in the frame summary display is set at 20, and the display frame interval is set at equal intervals. The slide volume 21c is set at a standard position (zero position). That is, the time interval when determining the frame image group directly uses a value automatically calculated by data attributes and parameter value set beforehand in the image processor, and adjustment corresponding to the amount of shift of the slide volume 21c is not performed.

In FIG. 7, first, the counter n is set at [1] (S51). The counter n shows the number of frames for which a frame number has been determined as frames to be displayed (display frames). Then, the frame interval d is determined when determining the display frames (S52). Since the frame interval is set at equal intervals as previously described, the display frame interval d is determined by the equation below from the number of frames displayed in the frame summary (hereinafter referred to as “display frame number”), and the total number of frames in one dynamic image.

d=int(total frame number/display frame number) (1)

Where function int ( ) is a function acquiring only integers. The total frame number of file Mf000003.avi is 100 frames, and since the specific display frame number is 20, the display frame interval d is set at 5.

Then, a determination is made as to whether or not the counter n value is greater than the display frame number (S53). If the counter n value is greater, this process ends, and the routine returns.

When the counter n value is equal to or less than the display frame number (i.e., 20), the display frame number feme(n) (where n=1˜20) is determined.

feme(n)=d×n−1 (2)

Thereafter, the count n value is incremented (S55), the routine returns to step S53, and the display frame number is sequentially determined in the same manner as described above. The frame number feme of the file Mf000003.avi is determined as described below.

feme(1)=4

feme(2)=9

. . .

feme(19)=94

feme(20)=99

FIG. 6 shows an example of frame images of a determined number of display frames displayed as still images. The user can specify a still image for printing by the icon 21a and operating the mouse 25 or the like. Since the frame images displayed in the frame summary are displayed at equal intervals over the entire time range of the dynamic image, the user can readily detect a desired image, thereby reducing the load on the user when selecting one still image from a dynamic image.

In this example, since the value of the slide volume 21c is set at the standard position, the frame display interval d is determined using equation (1), and the determined value is used directly; however, when the value of the slide volume 21c is shifted from the standard position, the value determined by equation (1) is increased or decreased by the amount of shift as a standard value, so as to adjust the interval d. In this way, even when a user cannot initially find a desired image from among a group of displayed frames, another frame image group can be displayed by modifying the display interval d, such that a desired image can be readily found. At this time, when the slide volume 21c setting is modified by the user, the interval d is recalculated, the image display is immediately updated and the determined frame image group is displayed as a frame summary at the new interval d.

In the image processor of the present embodiment as described above, an image group at equal time intervals is determined from among a plurality of still images (frame images) comprising the dynamic image specified by the user, and the user can readily select a desired image from among the image group in the summary display.

Second Embodiment

This embodiment shows another example of the image display process (step S15 of the first embodiment). That is, a selected frame image is intermittently shown in summary display at a specified interval in the complete range of the time range of the dynamic image in the first embodiment; however, in the second embodiment a frame image displayed by a timing specified by the user from among the frame images included in the dynamic image is displayed in the center of a group of frame images preceding and following the user-specified frame image.

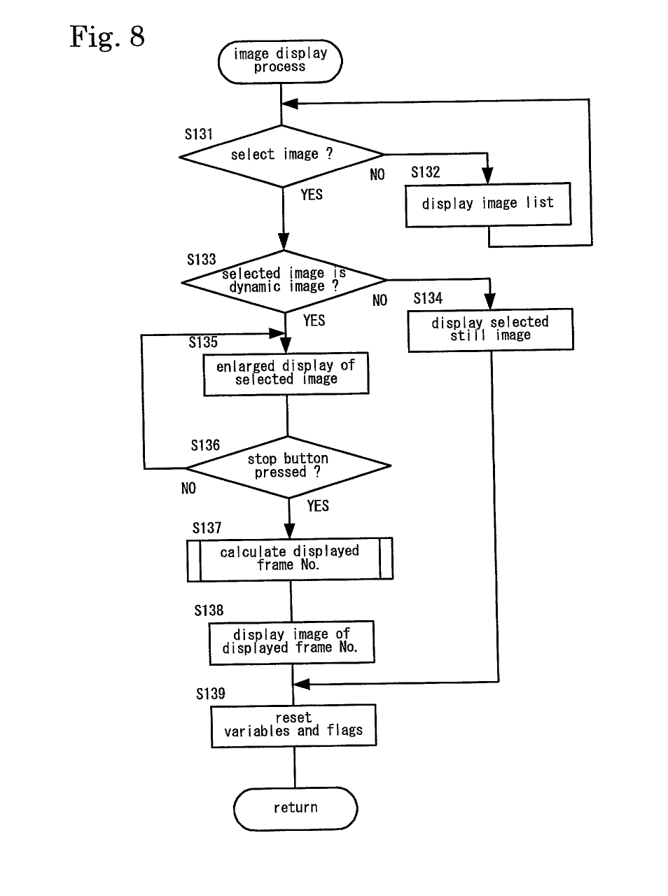

The image display process of the present embodiment is described below with reference to FIG. 8. Although this process is basically similar to the image display process of the first embodiment (refer to FIG. 3), the present process differs in that steps (S135 and S136) are added for determining the frame image at the center of the display in the frame summary, and the step S137) for calculating the display frame number.

In FIG. 8, first, a determination is made as to whether or not a user has selected an image through the keyboard 23 and mouse 25 (S131). If an image has not been selected, thumbnail images of images expanded from the recording medium are displayed in summary (refer to FIG. 4) (S132).

If a user has selected one image from among the image summary (S131), a determination is made as to whether or not the selected image is a dynamic image (S133), and if the selected image is a still image, the image is enlarged and displayed as shown in FIG. 5 (S134), and the routine advances to step S139.

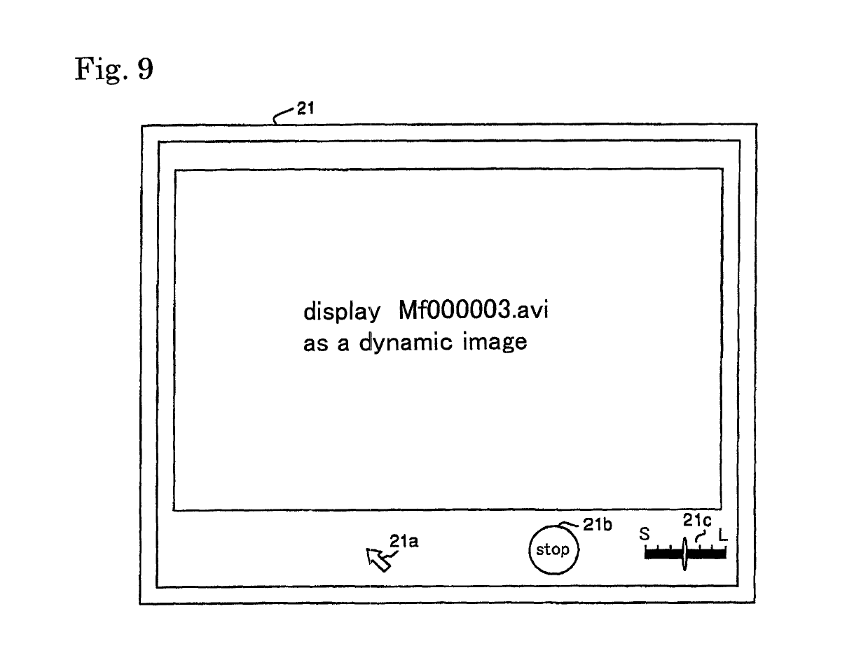

On the other hand, when the selected image is a dynamic image, the image is enlarged and displayed as shown in FIG. 9 (S135). At this time the enlarged display of the image is a dynamic image display. As shown in the drawing, the dynamic image is displayed on the screen together with a stop button 21b for stopping the dynamic image, and a slide volume 21c for adjusting the display frame interval. These items are operated by icon 21a. As a user views the dynamic image displayed on the screen, the user presses the stop button 21b by operating the icon 21a with a timing such that an image which the user wants to print is being displayed.

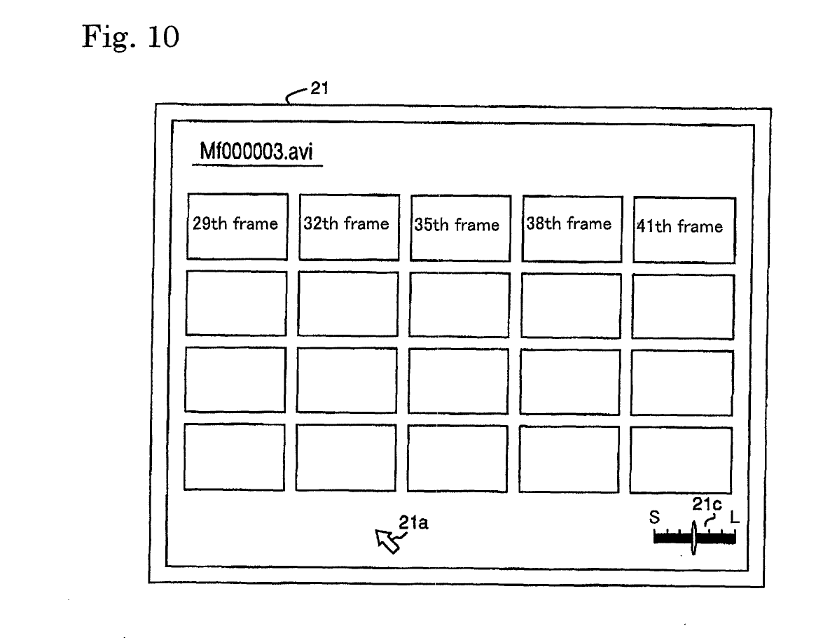

The CPU 11 monitors the pressing of the stop button 21b by the user (S136), recognizes this operation, and executes a process to display a frame summary. That is, first, a process is executed to determine the frame numbers of the frame images displayed in the frame summary (S137). (Details of this process are described later). Then, the frame images having the determined frame number are displayed as a frame summary on the screen 21 (S138). Thereafter, the variable and flags are reset (S139), and the routine returns. FIG. 10 shows an example of a frame summary display of the present embodiment. As shown in the drawing, the frame image group is displayed together with the slide volume 21c, and when the user modifies the set value of the slide volume 21c on this screen, the frame interval d is automatically recalculated, and the screen display is updated with the new frame image group.

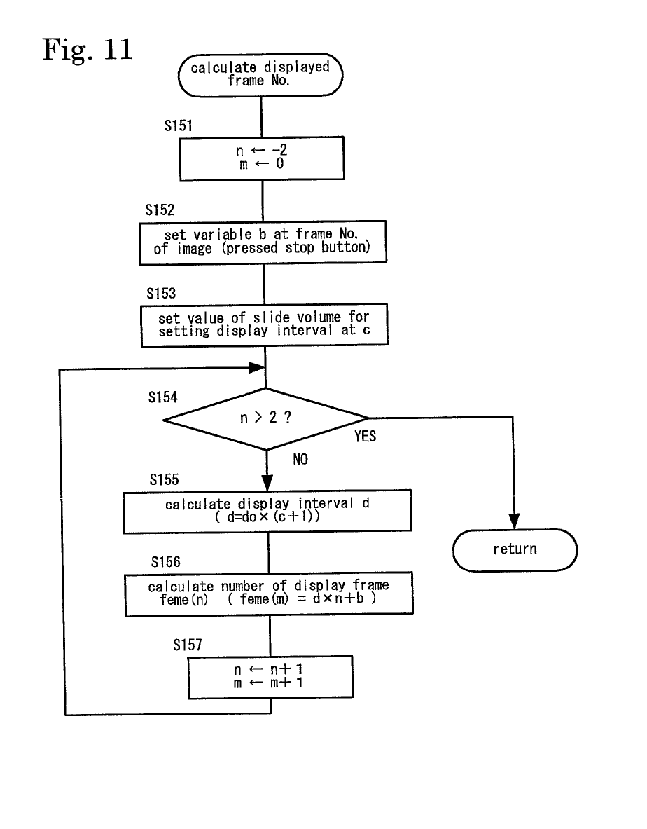

The display frame number calculation process (step S137) is described below with reference to FIG. 11. Below, the frame image timed with the pressing of the stop button 21b is designated the center, and the images of two frames at specific intervals preceding and following the center frame are displayed in the frame summary.

Referring to FIG. 11, first, the variable n used in the following process is set at [−2], and the variable m is set at [0] (S151). Then, the frame number of the frame image displayed when the stop button 21b was pressed is set at variable b (S152). The set value of the slide volume 21c used for setting the display interval is set at variable c (S153). The set value of the slide volume 21c can be any of three values 1, 2, 3 corresponding to the amount of shift of the slide volume 21c. The display frame interval d is determined by the set value c of the slide volume 21c and the standard display interval d0. The display interval d increases as the set value c of the slide volume 21c becomes larger.

Then, a determination is made as to whether or not the variable n is greater than a specific value (i.e., [2] in this case) (S154). The specific value is determined by the specified number of frames displayed in the frame summary. Since two frames preceding and following the image shown when the stop button 21b was pressed are displayed, the specific value becomes [2]. If the variable n is greater than the specific value, the process ends and the routine returns.

When the variable n is [2] or less, the display frame d is determined (S155). The display frame interval d is determined by the equation below from the standard display frame interval d0 and the set value c of the slide volume 21c.

d=d0×(c+1) (3)

The display frame number feme(m) (where m=1˜5) is determined (S156).

feme(m)=d×n+b (4)

Thereafter, the variables m and n are incremented (S157), the routine returns to step S154, and thereafter each frame number is sequentially determined in the same manner.

Regarding the file Mf000003.avi, when the stop button 21b is pressed at the 35^{th} frame (i.e., b=35), the standard display frame interval d0 is at [3], and the set value c of the slide volume 21c is set at the standard position (i.e., [0]), the display frame number feme(m) is determined as shown below, and every third frame image is shown with the 35^{th} frame as the center as shown in FIG. 10.

feme(0)=29

feme(1)=32

feme(2)=35

feme(3)=38

feme(4)=41

Each parameter also may be set such that the display frame interval d becomes [1], and the frame image group preceding and following consecutively from the center frame may be displayed in the frame summary display. In this way even when the timing of the user operation of pressing the stop button 21b shifts from a desired timing, the user can accurately select a desired target image because the images preceding and following the stopped frame image are displayed.

In the above examples, the frames at each equal interval (three frames) from the frame at which the stop button 21b was pressed are displayed; however, the interval also may be made unequal by suitable modification of equation (3). That is, frames may be displayed which are near to or distant from the frame at which the stop button 21b was pressed. This arrangement allows equation (3) to be set according to the equation below.

d=d0×(c+1)×n2 (3′)

According to equation (3′), when the stop button 21b is pressed at the 35^{th} frame (i.e., b=35), the standard display frame interval d0 is [3], and the set value c of the slide volume 21c is the standard position, then the display frame number feme(m) is determined in the manner described below.

feme(0)=11

feme(1)=32

feme(2)=35

feme(3)=38

feme(4)=59

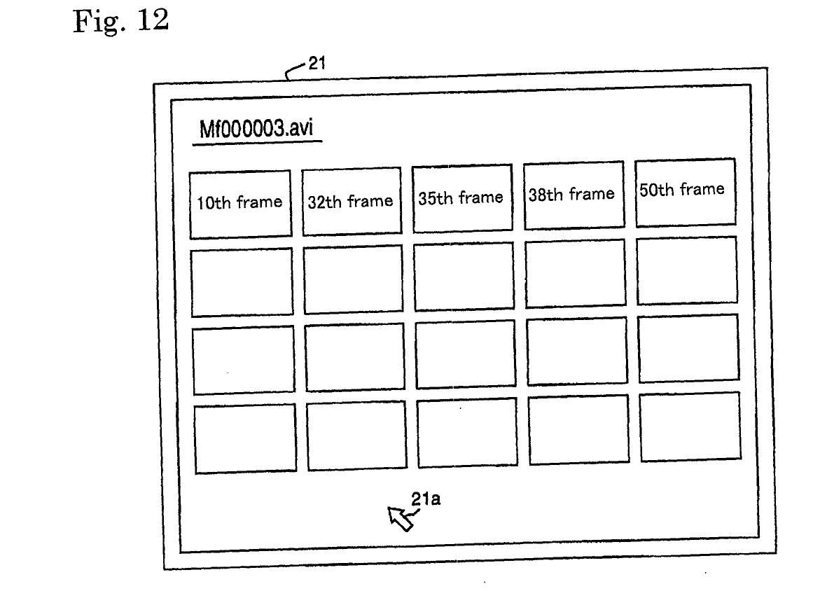

At this time, each frame image is displayed as shown in FIG. 12. In this way the view of the entire dynamic image is improved by increasing the interval, therefore making greater the separation from the center frame.

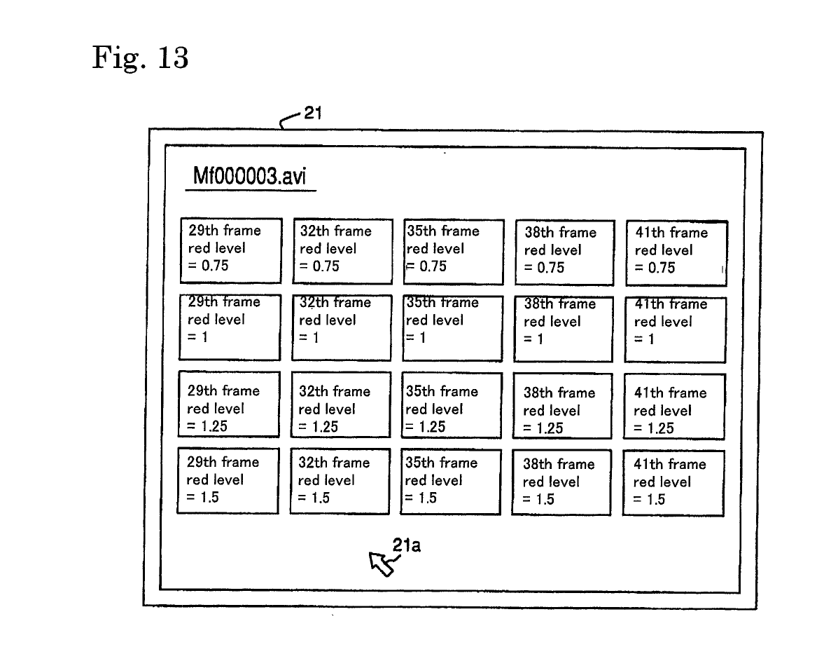

In the summary display (step 138), after each image of the determined frame image group is subjected to specific processing, these images also may be displayed. More specifically, the parameters contributing to the quality of each image may be modified and these images displayed. For example, the parameters of each image may be changed to have red levels of 0.65, 1.0, 12.25. 1.50 for the respective images, as shown in FIG. 13. In this way a user can quickly confirm the image after image processing, and image processing efficiency is improved.

In the image processor of the present embodiment described above, a still image group is determined within a specific range temporally preceding and following a center frame image (still image) displayed with a user-specified timing in a dynamic image display from among a group of still images comprising the dynamic image, and the determined group of images is displayed in summary. In this way a user need not accurately specify one frame of a dynamic image, and can readily select a desired image from among a plurality of images simply by specifying an image with an approximate timing, thereby reducing the work during image selection.

Although processing has been described in terms of selecting an image from a recording medium for print processing of image data in the embodiments described above, a selected image may not only be subjected to a subsequent printing process, but also may be subjected to general image processing such as an editing process and the like.

The image processor of the present invention displays a frame image (still image) displayed with a specified timing in a dynamic image display from among a group of still images comprising the dynamic image, and displays, with this frame image as a center image, a group of still images in a specific range temporally preceding and following the frame image as a center frame image. In this way the user need not accurately specify one frame when selecting one image from a group of frame images comprising a dynamic image, and is able to easily select a desired image simply by specifying an image with an approximate timing, thereby reducing the work during image selection.

Another image processor of the present invention performs specific image processing on a frame image (still image) displayed with a specified timing in a dynamic image display from among a group of still images comprising the dynamic image, and displays this specifically processed image. In this way the user can quickly confirm an image after image processing, thereby improving image processing efficiency.

Although preferred embodiments of the invention have been described in the foregoing detailed description and illustrated in the accompanying drawings, it will be understood that the invention is not limited to the embodiments disclosed, but is capable of numerous rearrangements, modifications and substitutions of parts and elements without departing from the spirit of the invention. Accordingly, the present invention is intended to encompass such rearrangements, modifications and substitutions of parts and elements as fall within the spirit and scope of the invention.

What is claimed is:

1. An image processor comprising:
a display device displaying a dynamic image, the dynamic image having a plurality of temporally consecutive frame images;
a stopping device stopping a display of the dynamic image displayed on the display device with an optional timing; and
a display controller displaying a plurality of still images on the display device, the plurality of still images being a frame image displayed with a stop timing and a group of frame images in a specified range having the stopped frame image as a center frame image, and the optional timing capable of being set to increase a temporal separation between adjacent frame images in the group of frame images.

2. An image processor as claimed in claim 1, wherein the display controller does not display the dynamic image when displaying a still image.

3. An image processor as claimed in claim 1, further comprising a selector selecting one image among the images displayed on the display device for specific processing.

4. An image processor as claimed in claim 3, further comprising a printing device printing the one image selected by the selector.

5. An image processor comprising:
a display device displaying a dynamic image, the dynamic image having a plurality of temporally consecutive frame images;
a stopping device stopping a display of the dynamic image displayed on the display device with an optional timing;
a display controller displaying a plurality of still images on the display device, the plurality of still images being a frame image displayed with a stop timing and a group of frame images in a specified range having the stopped frame image as a center frame image; and
a setting device setting a time spacing between frame images in the group of frame images.

6. An image processor as claimed in claim 5, wherein the display controller is capable of modifying the time spacing, and updating the display of the display device to display the group of frame images at a modified time interval.

7. An image processor as claimed in claim 5, further comprising a selector selecting one image among the images displayed on the display device for specific processing.

8. An image processor as claimed in claim 7, further comprising a printing device printing the one image selected by the selector.

9. An image processor comprising:
a display device displaying a dynamic image, the dynamic image having a plurality of temporally consecutive frame images;
a stopping device stopping the display of the dynamic image displayed on the display device with an optional timing; and
a display controller subjecting a frame image displayed with a stop timing to image processing and display on the display device when the dynamic image is stopped by the stopping device, and the display subjecting a group of frame images temporally before and after a center frame image to image processing and display as still images on the display device.

10. An image processor as claimed in claim 9, further comprising a selector selecting one image among the images displayed on the display device for specific processing.

11. An image processor as claimed in claim 10, further comprising a printing device printing the one image selected by the selector.

12. A method for image processing comprising:
displaying a dynamic image having a plurality of temporally consecutive frame images;
stopping a display of the dynamic image displayed on the display device with an optional timing; and
displaying a plurality of still images on the display device, the plurality of still images being a frame image displayed with a stop timing and a group of frame images in a specified range having the stopped frame image as a center frame image, and the optional timing capable of being set to increase a temporal separation between adjacent frame images in the group of frame images.

13. A method for image processing comprising:
displaying a dynamic image having a plurality of temporally consecutive frame images;
stopping a display of the dynamic image displayed on the display device with an optional timing;
displaying a plurality of still images on the display device, the plurality of still images being a frame image displayed with a stop timing and a group of frame images in a specified range having the stopped frame image as a center frame image; and
setting a time spacing between frame images in the group of frame images.

14. A method for image processing comprising:
displaying a dynamic image having a plurality of temporally consecutive frame images;
stopping a display of the dynamic image displayed on the display device with an optional timing; and
subjecting a frame image displayed with a stop timing to image processing and display on the display device when the dynamic image is stopped by the stopping device, and the display subjecting a group of frame images temporally before and after a center frame image to image processing and display as still images on the display device.

15. A computer-readable medium having stored thereon a plurality of sequences of instructions, the plurality of sequences of instructions including sequences of instructions, which, when executed by a processor, cause the processor to perform the step of implementing a process for:
displaying a dynamic image having a plurality of temporally consecutive frame images;
stopping a display of the dynamic image displayed on the display device with an optional timing; and
displaying a plurality of still images on the display device, the plurality of still images being a frame image displayed with a stop timing and a group of frame images in a specified range having the stopped frame image as a center frame image, and the optional timing capable of being set to increase a temporal separation between adjacent frame images in the group of frame images.

16. A computer-readable medium having stored thereon a plurality of sequences of instructions, the plurality of sequences of instructions including sequences of instructions, which, when executed by a processor, cause the processor to perform the step of implementing a process for:
displaying a dynamic image having a plurality of temporally consecutive frame images;
stopping a display of the dynamic image displayed on the display device with an optional timing;
displaying a plurality of still images on the display device, the plurality of still images being a frame image displayed with a stop timing and a group of frame images in a specified range having the stopped frame image as a center frame image; and
setting a time spacing between frame images in the group of frame images.

17. A computer-readable medium having stored thereon a plurality of sequences of instructions, the plurality of sequences of instructions including sequences of instructions, which, when executed by a processor, cause the processor to perform the step of implementing a process for:
displaying a dynamic image having a plurality of temporally consecutive frame images;
stopping a display of the dynamic image displayed on the display device with an optional timing; and
subjecting a frame image displayed with a stop timing to image processing and display on the display device when the dynamic image is stopped by the stopping device, and the display subjecting a group of frame images temporally before and after a center frame image to image processing and display as still images on the display device.

18. An image processing apparatus comprising:
a display device displaying a dynamic image and a first plurality of still images;
a selector selecting one of the dynamic image and the first plurality of still images;
a stopping device stopping a display of the dynamic image displayed, when the dynamic image is selected, on the display device with an optional timing; and
a display controller displaying a second plurality of still images on the display device, the second plurality of still images being a frame image displayed with a stop timing and a group of frame images in a specified range having the stopped frame image as a center frame image.
